(19) United States
(12) Patent Application Publication
(10) Pub. No.: US 2007/0285323 A1
(43) Pub. Date: Dec. 13, 2007

(54) HIGH FREQUENCY WAVE GLASS ANTENNA FOR AN AUTOMOBILE

(75) Inventors: Toshifumi Funatsu, Chiyoda-ku (JP); Akio Nagata, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Asahi Glass Company, Limited, Chiyoda-ku (JP)

(21) Appl. No.: 11/760,943

(22) Filed: Jun. 11, 2007

(30) Foreign Application Priority Data
Jun. 12, 2006 (JP) 2006-162171

(51) Int. Cl. H01Q 1/32

(52) U.S. Cl. 343/713

(57) ABSTRACT

An antenna conductor includes a first antenna element 1, a second antenna element 2, a first connecting conductor 3 and a loop-forming element 6; the first antenna element 1, the second antenna element 2 and the first connecting conductor 3 form a conductor pattern in a U-character shape; the first antenna element 1 is connected to a feeding electrode 8 through a second connecting conductor 4; and the first antenna element 1, the first connecting conductor 3 and the loop-forming element 6 form a loop.

### BACKGROUND OF THE INVENTION

1. Field of the Invention

The present invention relates to a high frequency wave glass antenna for an automobile, which is appropriate to receive a digital terrestrial television broadcast in Japan (470 to 770 MHz), a UHF band analog television broadcast in Japan (470 to 770 MHz), or a US digital television broadcast (698 to 806 MHz).

2. Discussion of Background

There is a high frequency wave glass antenna for an automobile, which receives a digital terrestrial television broadcast in Japan, wherein a feed point is formed at either one of the two leading edges of an antenna conductor (for example, JP-2006-270395, FIGS. 1 to 4).

However, this glass antenna has a problem in that the glass antenna can neither obtain a flat antenna gain and a flat F/B ratio nor deal with a broad frequency range of the Japanese digital terrestrial television broadcast band since the glass antenna has only a single resonant frequency because of having a simple structure. Further, FIG. 6 of this patent document describes a mode wherein the antenna conductor, which is formed in a substantially U-character shape, has a loop formed in the vicinity of a leading edge thereof so as to deal with such a broad frequency band. However, even this mode has a problem of insufficiently dealing with such a broad frequency range. It should be noted that this patent document was not known at the time when the earlier application, based on which the convention priority is claimed, was filed (i.e., Jun. 12, 2006).

### SUMMARY OF THE INVENTION

It is an object of the present invention to solve the above-mentioned problems of the art described in the patent document and to provide a high frequency wave glass antenna for an automobile, which has not been known yet.

The present invention provides a high frequency wave glass antenna comprising:

an antenna conductor and a feeding electrode for the antenna conductor disposed in or on an automobile window glass sheet, a signal received by the feeding electrode being transmitted to a receiver; and

the antenna conductor including a first antenna element, a second antenna element, a first connecting conductor and a loop-forming element;

wherein the first antenna element and the second antenna element are connected together by the first connecting conductor, such that the first antenna element, the second antenna element and the first connecting conductor form a conductor pattern in a U-character shape, a substantially U-character shape, a J-character shape or a substantially J-character shape;

wherein at least one of the first antenna element and the loop-forming element is directly connected to the feeding electrode or connected to the feeding electrode through a second connecting conductor disposed as required;

wherein when at least one of the first antenna element and the loop-forming element is directly connected to the feeding electrode, at least one of the first antenna element, the first connecting conductor and the feeding electrode, and the loop-forming element form a loop; and

wherein when at least one of the first antenna element and the loop-forming element are connected to the feeding electrode through the second connecting conductor, at least one of the first antenna element, the first connecting conductor, the second connecting conductor and the feeding electrode, and the loop-forming element form a loop.

The antenna conductor according to the present invention has a plurality of resonant frequencies because of having the loop. Accordingly, even if a desired broadcasting frequency band comprises a broad range of broadcasting frequency band, such as a digital terrestrial television broadcast in Japan, a UHF band analog television broadcast in Japan, or a US digital television broadcast, it is possible to obtain not only a high antenna gain and a high F/B ratio but also a flat antenna gain and F/B ratio without damaging the sight through the window or the appearance. The present invention can contribute to make the antenna smaller since the area occupied by the antenna conductor and the feeding electrode is small.

When the window glass sheet comprises a laminated glass sheet, the antenna according to the present invention is appropriate as a high frequency wave glass antenna for the front windshield of an automobile since the antenna conductor can be disposed between two glass sheets forming the laminated glass sheet.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a plan view showing the high frequency wave glass antenna for an automobile according to an embodiment of the present invention;

FIG. 2 is a plan view showing another embodiment, which is different from the embodiment shown in FIG. 1;

FIG. 3 is a structural view of a portion of a window glass sheet in the vicinity of a feeding electrode and a grounded portion as viewed from substantially above in FIG. 2;

FIG. 4 is a plan view showing another embodiment, which is different from the embodiment shown in FIG. 1;

FIG. 5 is a characteristic graph of frequency-antenna gain in Example 1;

FIG. 6 is a characteristic graph of frequency-F/B ratio in Example 1;

FIG. 7 is a characteristic graph of P-antenna gain in Example 1;

FIG. 8 is a characteristic graph of P-F/B ratio in Example 1;

FIG. 9 is a characteristic graph of frequency-antenna gain in Example 2;

FIG. 10 is a characteristic graph of frequency-F/B ratio in Example 2;

FIG. 11 is a characteristic graph of P-antenna gain in Example 2;

FIG. 12 is a characteristic graph of P-F/B ratio in Example 2;

FIG. 13 is a plan view showing another embodiment, which is different from the embodiments shown in FIGS. 1, 2 and 4; and

FIG. 14 is a characteristic graph of frequency-antenna gain in Example 3.

### DETAILED DESCRIPTION OF THE INVENTION

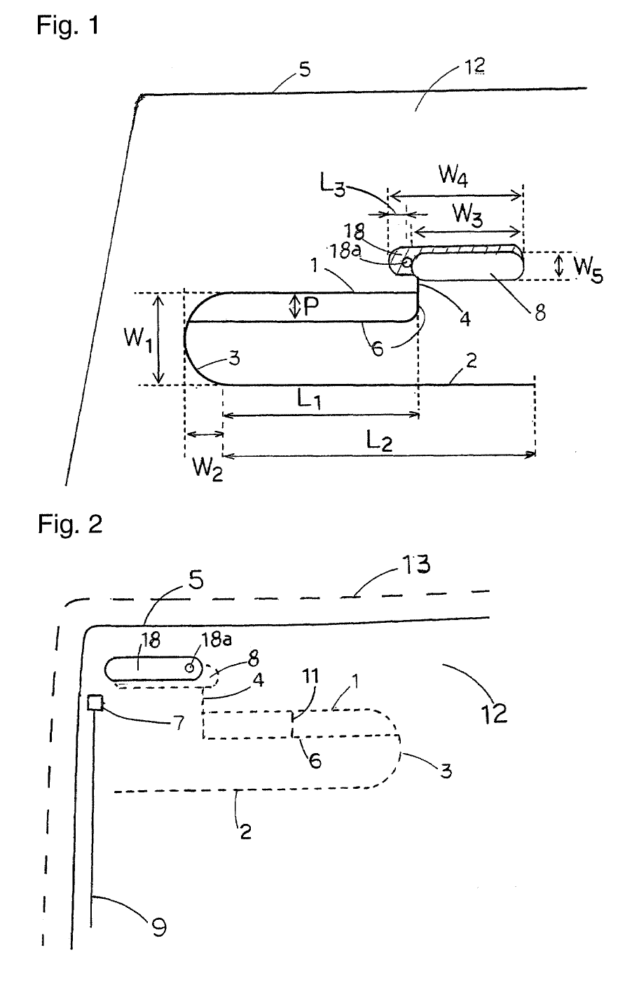

Now, the high frequency wave glass antenna for an automobile according to the present invention will be described in detail based on preferred embodiments, which are shown in the accompanying drawings. FIG. 1 is a plan showing the high frequency wave glass antenna for an automobile according to an embodiment of the present invention.

In FIG. 1, reference symbol 1 designates a first antenna element, reference symbol 2 designates a second antenna element, reference symbol 3 designates a first connecting conductor, reference symbol 4 designates a second connecting conductor, which is disposed as required, reference symbol 5 designates a vehicle opening edge for a window (which is shown as an upper portion of a vehicle opening edge for a window in FIG. 1), reference symbol 8 designates a feeding electrode, reference symbol 12 designates a window glass sheet for an automobile, reference symbol 18 designates an opposite electrode, and reference symbol 18a designates a feed point formed in the opposite electrode 18. The following explanation will be made, abbreviating the first antenna element as the first element and the second antenna element as the second element.

In the following explanation, the directions are referred to, based on the directions on the accompanying drawings, unless otherwise specified. FIG. 1 is a view seen from a car-exterior-side. FIG. 1 does not show a peripheral edge portion of the window glass sheet 12.

In the present invention, the antenna conductor comprises the first element 1, the second element 2, the first connecting conductor 3 and a loop-forming element 6. The present invention is applicable to two types of a monopole antenna and a dipole antenna. The type shown in FIG. 1 is directed to a monopole antenna. In a monopole antenna, a signal received by the feeding electrode 8 is transmitted to a receiver (not shown). In a dipole antenna, a signal received between the feeding electrode 8 and a grounded portion is transmitted to a receiver (not shown).

In the following explanation, the explanation of the antenna conductor and the feeding electrode 8 is common to both of a monopole antenna and a dipole antenna, and the explanation of a grounding conductor 9 and the grounded portion 7 is applicable only to a dipole antenna.

In the embodiment shown in FIG. 1, the window glass sheet 12 comprises a laminated glass sheet which comprises two glass sheets bonded together through a bonded layer. The two glass sheets comprise a car-interior-side glass sheet and a car-exterior-side glass sheet. The first element 1, the second element 2, the first connecting conductor 3, the loop-forming element 6 and the feeding electrode 8 as well as the second connecting conductor 4 disposed as required are disposed between the car-interior-side glass sheet and the car-exterior-side glass sheet. In the case of this type, for example, at least one of the first element 1, the second element 2, the first connecting conductor 3, the loop-forming element, the feeding electrode 8 and the second connecting conductor 4 (which is disposed as required) is disposed either one of the confronting surfaces of the two glass sheets through the bonding layer.

In FIG. 1, the opposite electrode 18 is disposed at a portion of the car-interior-side surface of the laminated glass sheet (the car-interior-side surface of the car-interior-side glass sheet), which is opposite to the feeding electrode 8, and a signal received by the feeding electrode 8 is transmitted to the opposite electrode 18 by at least one of capacitive coupling and electromagnetic coupling. The signal received by the opposite electrode 18 is transmitted to the receiver. In order to improve the transmission efficiency in transmission of a signal from the feeding electrode 8 to the opposite electrode 18, it is preferred that the first element 1, the second element 2, the first connecting conductor 3, the loop-forming element 6, the feeding electrode 8 and the second connecting conductor 4 (which is disposed as required) be disposed on a surface of the car-interior-side glass sheet close to the bonding layer.

In the embodiment shown in FIG. 1, the window glass sheet 12 comprises the laminated glass sheet. However, the window glass sheet according to the present invention is not limited to a laminated glass sheet. The window glass sheet 12 may comprise a single glass sheet. When the window glass sheet 12 comprises a single glass sheet, the antenna conductor and the feeding electrode 8 as well as the second connecting conductor 4 disposed as required are normally disposed on the car-interior-side surface of the window glass sheet 12, the opposite electrode 18 may be eliminated, and a signal received by the feeding electrode 8 is transmitted to the receiver.

In the present invention, the first element 1 and the second element 2 are connected by the first connecting conductor 3. The first element 1, the second element 2 and the first connecting conductor 3 form a conductor pattern in a U-character shape, substantially U-character shape, a J-character shape or a substantially J-character shape.

In the embodiment shown in FIG. 1, the first element 1 and the loop-forming element 6 are connected to the feeding electrode 8 through the second connecting conductor 4. However, the present invention is not limited to this mode. At least one of the first element 1 and the loop-forming element 6 may be connected to the feeding electrode 8 through the second connecting conductor 4. Alternatively, at least one of the first element 1 and the loop-forming element 6 may be directly connected to the feeding electrode 8.

In the embodiment shown in FIG. 1, the first element 1, the first connecting conductor 3 and the loop-forming element 6 form a loop. However, the present invention is not limited to this mode. The present invention may have the following modes:

When at least one of the first element 1 and the loop-forming element 6 is directly connected to the feeding electrode 8, at least one of the first element 1, the first connecting conductor 3 and the feeding electrode 8, and the loop-forming element 6 form such a loop.

When at least one of the first element 1 and the loop-forming element 6 is connected to the feeding electrode 8 through a second connecting conductor 4, at least one of the first element 1, the first connecting conductor 3, the second connecting conductor 4 and the feeding electrode 8, and the loop-forming element 6 form such a loop.

In the embodiment shown in FIG. 1, a leading edge of the first element 1 remote from the first connecting conductor 3 is connected to the second connecting conductor 4. However, the present invention is not limited to this mode, and a portion of the first element in the vicinity of the leading edge may be connected to the second connecting conductor 4. When the second connecting conductor 4 is not disposed, the leading edge of the first element 1 remote from the first connecting conductor 3 or a portion of the first element in the vicinity of the leading edge may be directly connected to the feeding electrode 8.

In FIG. 1, the first element 1 has a straight portion disposed in the vicinity of the vehicle opening edge for a window 5, and the straight portion extends parallel or substantially parallel to the vehicle opening edge for a window 5. In the present invention, the vehicle opening edge for a window is a peripheral edge of a vehicle opening, into which the window glass sheet is fitted, and which serves as vehicle grounding and is made of a conductive material, such as metal.

In the embodiment shown in FIG. 1, the feeding electrode 8 is disposed on a side opposite to the first connecting conductor 3 as viewed from the center of the first element 1. The loop-forming element 6 starts at a certain portion of the first connecting conductor 3 and extends parallel or substantially parallel to the first element 1 toward the feeding electrode 8. The loop-forming element 6 curves or bends towards the feeding electrode 8 in the vicinity of the feeding electrode 8, and is connected to a leading edge of the first element 1 close to the feeding electrode 8 or a portion of the first element in the vicinity of the leading edge close to the feeding electrode. This connection point is connected to the feeding electrode 8 through the second connecting conductor 4. The present invention is not limited to this mode, and this connection point may be directly connected to the feeding electrode 8.

FIG. 2 is a plan view (seen from the car-interior-side) showing another embodiment, which is different from the embodiment shown in FIG. 1. In the embodiment shown in FIG. 2, as in the embodiment shown in FIG. 1, a first element 1, a second element 2, a first connecting conductor 3, a loop-forming element 6 and a feeding electrode 8 are disposed between the car-interior-side glass sheet and the car-exterior-side glass sheet. As in the embodiment shown in FIG. 1, an opposite electrode 18 is disposed on the car-interior-side surface of the car-interior-side glass sheet, and a feed point 18a is disposed in the opposite electrode 18.

In the vicinity of the opposite electrode 18, the grounded portion 7 is disposed on the car-interior-side surface of the car-interior-side glass sheet. A signal received between the opposite electrode 18 and the grounded portion 7 is transmitted to the receiver. The grounded portion 7 is connected to the grounding conductor 9 as required. It is preferred from the viewpoint of improving the antenna gain and the F/B ratio that the shortest distance between the feeding electrode 8 and the grounded portion 7 be from 2 to 30 mm. In FIG. 2, reference symbol 13 designates a peripheral edge portion of the window glass sheet.

In the embodiment shown in FIG. 2, the feeding electrode 8 and the grounded portion 7 are both disposed in the vicinity of an upper left corner of the window glass sheet 12. The grounding conductor 9 has a main portion extending downward from the grounded portion 7 along a left side of the vehicle opening edge for a window. The embodiment described in reference to FIG. 2 is not limited to the mode shown in FIG. 2, and the window glass sheet 12 may comprise a single glass sheet. For an example, the antenna conductor and the feeding electrode 8 as well as the second connecting conductor 4 disposed as required may be disposed on the car-interior-side surface of a single window glass sheet 12, and the grounded portion 7 disposed in the vicinity of the feeding electrode 8 as well as the grounding conductor 9 disposed as required may be disposed on the car-interior-side surface. In this case, a signal received between the feeding electrode 8 and the grounded portion 7 is transmitted to the receiver.

In the present invention, it is preferred in the viewpoint of improving the antenna gain that an antenna element for short circuit, which connects between an arbitrary point of the loop and a point of the loop other than the arbitrary point. In FIG. 2, the antenna element for short circuit 11 is shown to divide the loop into sections having an equal area. In FIG. 2, the antenna element for short circuit 11 forms a right angle or a substantially right angle with a straight portion of the first element 1. It is preferred from the viewpoint of improving the antenna gain in intermediate and high frequencies in a desired broadcasting frequency band.

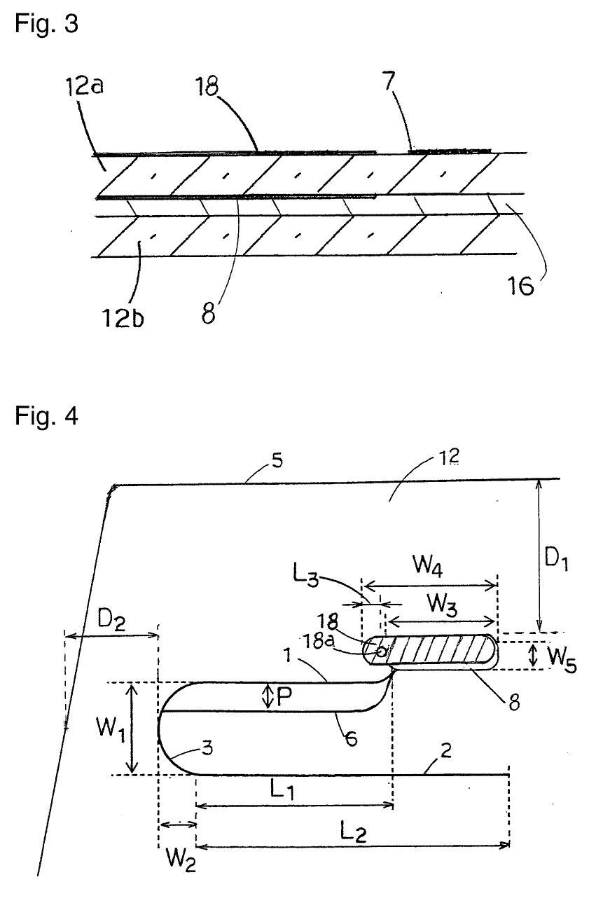

In FIG. 3, a portion of the window glass sheet 12 in the vicinity of the feeding electrode 8 and the grounded portion 7 is seen from substantially above in FIG. 2. When the window glass sheet 12 comprises a laminated glass sheet, the window glass sheet 12 includes a car-interior-side glass sheet 12a, a car-exterior-side glass sheet 12b and an intermediate film 16 made of a synthetic resin between the car-interior-side glass sheet 12a and the car-exterior-side glass sheet 12b. The car-interior-side glass sheet 12a and the car-exterior-side glass sheet 12b are bonded by the intermediate film 16, and the intermediate film 16 serves as a bonding layer.

Although all portions of the antenna conductor are not shown in FIG. 3, the antenna conductor and the feeding electrode 8 are disposed on a surface of the car-interior-side glass sheet 12a close to the intermediate film. However, the present invention is not limited to this mode, and the antenna conductor and the feeding electrode 8 may be disposed on a surface of the car-exterior-side glass sheet 12b close to the intermediate film 16.

At least one of the first element 1, the second element 2, the first connecting conductor 3, the loop-forming element 6, the feeding electrode 8 and the second connecting conductor 4 (which is disposed as required) may be disposed on one of the confronting surfaces of the two glass sheets through the bonding layer. The antenna conductor and the feeding electrode 8 may be disposed in the intermediate film 16.

FIG. 4 shows a plan view (seen from the car-interior-side) of another embodiment, which is different from the embodiment shown in FIG. 1. In FIG. 4, a feeding electrode 8 is disposed on a side opposite to a first connecting conductor 3 as seen from the center of a first element 1. A loop-forming element 6 starts at a certain portion of the first connecting conductor 3 and extends parallel or substantially parallel to the first element 1 toward the feeding electrode 8. The first element 1 and the loop-forming element 6 join together in the vicinity of the feeding electrode 8, being directly connected to the feeding electrode. The present invention is not limited to this mode. The first element 1 and the loop-forming element 6 may join together in the vicinity of the feeding electrode 8 and may be connected to the feeding electrode through a second connecting conductor.

In the embodiment shown in FIG. 4, the antenna conductor, the feeding electrode 8 and an opposite electrode 18 are disposed in the vicinity of an upper left corner of the window glass sheet 12. The antenna conductor and the feeding electrode 8 are disposed between the car-interior-side glass sheet and the car-exterior-side glass sheet, and the opposite electrode 18 is disposed on the car-interior-side surface of the car-interior-side glass sheet.

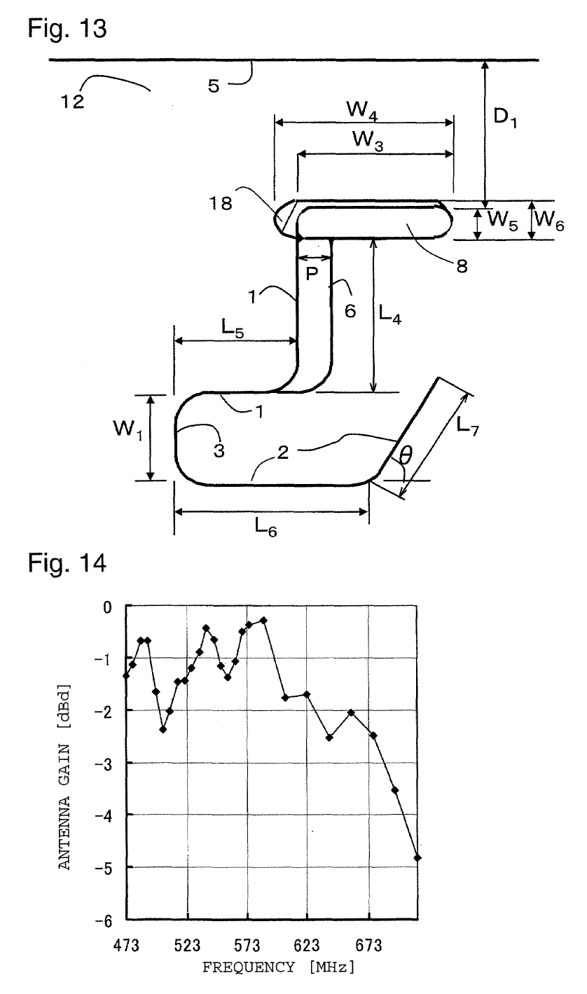

FIG. 13 shows another embodiment, which is different from the embodiments shown in FIGS. 1, 2 and 4. When a conductor pattern formed in a U-character shape, a substantially U-character shape, a J-character shape or a substantially J-character shape is called a turn conductor pattern, the turn conductor pattern comprises a portion of a first element 1, a second element 2 and a first connecting conductor 3 in the embodiment shown in FIG. 13. By adopting this type of mode, it is possible to reduce the transverse size of the antenna conductor.

The turn conductor pattern according to the present invention is not limited to have the mode shown in FIG. 13. In other words, the conductor pattern may comprise the first element 1, a portion of the second element 2 and the first connecting conductor 3. Further, the turn conductor pattern may comprise a portion of the first element 1, a portion of the second element 2 and the first connecting conductor 3.

The first element 1 may be extended in a direction away from the first connecting conductor 3, followed by being curved and extended toward an outer direction of the turn outer pattern. In the embodiment shown in FIG. 13, the first element 1 is curved at an right angle or a substantially right angle and is extended toward the outer direction of the turn outer pattern.

In the embodiment shown in FIG. 13, the second element 2 is extended in a direction away from the first connecting conductor 3, followed by being curved and extended toward an inner direction of the turn conductor pattern. By adopting this type of mode, it is possible to reduce the transverse size of the antenna conductor.

When a digital terrestrial television broadcast in Japan is received in the present invention, it is preferred from the viewpoint of improving the antenna gain and the F/B ratio in lower frequencies than the center frequency of the digital terrestrial television broadcasting band in Japan that the first element have a length of (1/2)·(359/4) to (3/2)·(359/4) mm. The first element has a length ranging preferably from 0.7·(359/4) to 1.3·(359/4) mm and more preferably from 0.8·(359/4) to 1.2·(359/4) mm. It should be noted that the value of 359 mm is the wavelength of glass for the center frequency (535 MHz) of the currently used frequency band (470 to 600 MHz) in the digital terrestrial television broadcasting band in Japan.

It is preferred from the viewpoint of improving the antenna gain and the F/B ratio that the first element 1, the first connecting conductor 3 and the second element 2 have a total length ranging from (3/2)·(359/4) to (9/2)·(359/4) mm. The total length ranges preferably from 2.1·(359/4) to 3.9·(359/4) mm and more preferably from 2.4·(359/4) to 3.6·(359/4) mm.

When the center frequency of a desired broadcasting frequency band has a wavelength of λ₀ in air, when glass has a shortening coefficient of wavelength of k, when the formula of k=0.64 is established, when the formula of λ_{g}=λ₀·k is established, when the first element 1 is one of the elements forming the loop, when a main portion of the first element 1 and a main portion of the loop-forming element 6 are parallel or substantially parallel to each other; it is preferred that the distance P between the main portion of the first element 1 and the main portion of the loop-forming element 6 be 0.0065λ_{g} or above. When the distance P is 0.0065λ_{g} or above, the antenna gain in low and high frequencies in a desired broadcasting frequency band can be improved, and the F/B ratio in the high frequencies in the desired broadcasting frequency band can be improved. The distance is preferably 0.0161λ_{g} or above and more preferably 0.0242λ_{g} or above.

The main portion of the first element 1 means a portion of the first element 1 that occupies a 70% or above of the conductor length thereof. The main portion of the loop-forming element 6 means a portion of the loop-forming element 6 that occupies 70% or above of the conductor length thereof. In each of the embodiments shown in FIGS. 1 and 2, the straight portion contained in the first element 1 is the main portion of the first element 1.

It is preferred from the viewpoint of improving the antenna gain and the F/B ratio that the first element 1 be one of the elements forming the loop, and that the average distance between the first element 1 and the loop-forming element 6 be 0.0065λ_{g} or above. The average distance between the first element and the loop-forming element is more preferably 0.0161λ_{g} or above, and particularly preferably 0.0242λ_{g} or above.

It is preferred from the viewpoint of improving the antenna gain and the F/B ratio that the average distance between the second element and the loop-forming element be 0.0065λ_{g} or above. The average distance between the second element and the loop-forming element is more preferably 0.0161λ_{g} or above, and particularly preferably 0.0242λ_{g} or above.

It is preferred from the viewpoint of improving the antenna gain and the F/B ratio that the distance between the first element 1 and the second element 2 range from 0.0565λ_{g} to 0.170λ_{g}. The distance between the first element and the second element more preferably ranges from 0.0791λ_{g} to 0.147λ_{g}.

In each of the embodiments shown in FIGS. 1 and 2, the first connecting conductor 3 is formed in the shape of an arc forming a semicircle, a substantially semicircle, a semi-oval or a substantially semi-oval, which is preferred from the viewpoint of improving the antenna gain and the F/B ratio. However, the present invention is not limited to this mode. The first connecting conductor 3 may be formed in, e.g., a straight line or a shape comprising a combination of a curved line and a straight line.

In each of the embodiments shown in FIGS. 1 and 2, the feeding electrode 8 is formed in such a shape as to have a longitudinal direction, and the longitudinal direction of the feeding electrode 8 extends parallel or substantially parallel to the extending direction or the longitudinal direction of the main portion of the first element 1, which are preferred from the viewpoint of improving the antenna gain and the F/B ratio. However, the present invention is not limited to this mode. It is also acceptable that the longitudinal direction of the feeding electrode 8 does not extend parallel or substantially parallel to the extending direction or the longitudinal direction of the main portion of the first element 1.

It is preferred from the viewpoint of improving the antenna gain and the F/B ratio that the feeding electrode 8 in the longitudinal direction has a maximum width of 0.0727λ_{g} to 0.218λ_{g}. The maximum width more preferably ranges from 0.102λ_{g} to 0.189λ_{g}.

When the opposite electrode 18 is disposed in the present invention, it is preferred from the viewpoint of improving the antenna gain and the F/B ratio that the maximum width of the opposite electrode 18 in a longitudinal direction thereof be 1.03 to 1.5 times the maximum width of the feeding electrode 8 in the longitudinal direction thereof. The maximum width of the opposite electrode in the longitudinal direction thereof is preferably 1.1 to 1.3 times the maximum width of the feeding electrode 8 in the longitudinal direction thereof.

When each of the feeding electrode 8 and the opposite electrode 18 is formed in such a shape as to have such a longitudinal direction, when the longitudinal direction of the feeding electrode 8 and the longitudinal direction of the opposite electrode 18 are parallel or substantially parallel to each other, and when the opposite electrode 18 has the feed point 18a disposed therein, it is preferred from the viewpoint of improving the antenna gain and the F/B ratio that the feed point 18a be disposed closer to the first element 1 than the center of the opposite electrode 18.

The present invention is applicable to two types of a monopole antenna and a dipole antenna, and the mode shown in FIG. 1 is directed to a dipole antenna. In FIG. 1, the antenna conductor, the feeding electrode 8, the grounding conductor 9 and the grounded portion 7 for the grounding conductor 9 are disposed at the window glass sheet 12, and a signal received between the feeding electrode 8 and the grounded portion 7 transmitted to the receiver. A monopole antenna is formed in such a mode that a signal received by the feeding electrode 8 is transmitted to the receiver without provision of the grounding conductor 9 and the grounded portion 7 in FIG. 1. In the following explanation, the explanation of the antenna conductor and the feeding electrode 8 is common to a monopole antenna and a dipole antenna, and the explanation of the grounding conductor 9 and the grounded portion 7 is applicable only to a dipole antenna.

In the present invention, when the window glass sheet 12 comprises a front windshield, it is preferred from the viewpoint of improving the F/B ratio that the window glass sheet 12 be inclined at an angle of 18 to 42°, in particular, 24 to 40° with respect to a horizontal direction.

In the present invention, at least one of the antenna conductor, the second grounding conductor 4, the feeding electrode 8, the grounded portion 7 and the grounding conductor 9 may have a conductor for phase adjustment, a conductor for adjustment of the antenna performance, a conductor for fine adjustment of the antenna performance, or another conductor attached thereto.

When the opposite electrode 18 is disposed, it is preferred that the center conductor of a coaxial cable (not shown) be connected to the feed point 18a. When the opposite electrode 18 is not disposed, it is preferred that the center conductor of the coaxial cable be connected to the feeding electrode 8.

When the grounded portion 7 is disposed, it is preferred that the outer conductor of the coaxial cable be electrically connected to the grounded portion 7. The coaxial cable is connected to an input end of the receiver. The way for connecting the coaxial cable to the feeding electrode 8 and the grounded portion 7 is not limited to direct connection by, e.g. soldering. The connection may be made by using a connector.

The window glass sheet 12, to which the high frequency wave glass antenna for an automobile according to the present invention is applied, may comprise any type of window glass sheet, such as a front windshield, a rear windshield, a side window glass sheet or a roof window glass sheet. There is no limitation to the type of the window glass sheet, to which the glass antenna according to the present invention is applied. Further, when the window glass sheet 12 comprises a laminated glass sheet, it is preferred in terms of safety that the window glass sheet including the glass antenna according to the present invention be used as a front windshield.

Each of the antenna conductor, the feeding electrode 8, the second grounding conductor 4, the grounding conductor 9 and the grounded portion 7 may be formed by printing paste containing conductive metal, such as silver paste, on the window glass sheet 12 and baking the printed paste. However, the present invention is not limited to this forming method. A linear member or foil member, which comprises a conductive substance, such as copper, may be formed on the window glass sheet 12 by an adhesive. A plastic film, which has a conductive layer formed therein or thereon, may be disposed on the car-interior-side surface or the car-exterior-side surface of is a widow glass sheet, or between two glass sheets forming a laminated glass sheet, so that respective sections of the conductive layer serve as the antenna conductor, the feeding electrode 8, the second grounding conductor 4, the grounding conductor 9 and the grounded portion 7. There is no limitation to the method for forming these elements.

In the present invention, the window glass sheet 12 may have a shielding film as a dielectric film formed thereon so that at least one of the antenna conductor, the feeding electrode 8, the second connecting conductor 4, the opposite electrode 18, the grounding conductor 9 and the grounded portion 7 is partly or entirely disposed on the shielding film. The shielding film may comprise a ceramic film, such as a black ceramic film. In this case, the window glass sheet 12 can have an excellent design to make the antenna device invisible from the car-exterior-side since the shielding film shields the portions of the antenna conductor and the other elements disposed thereon when the window glass sheet 12 is seen from the car-exterior-side. The intermediate film 16 may be made of polyvinylbutyral, for example.

Next, the present invention will be described in reference to examples. It should be noted that the present invention is not limited to these examples, and that variations or modifications are included in the present invention as long as the variations and modifications do not depart from the spirit of the invention.

Now, the examples will be described in detail, referring to drawings. A high frequency wave glass antenna for an automobile was fabricated in the arrangement shown in FIG. 4, using the front windshield mounted to an automobile (Example 1). A high frequency wave glass antenna for an automobile was also fabricated in the same way as the arrangement shown in FIG. 4 except that, instead of the antenna conductor shown in FIG. 4, the antenna conductor formed in the arrangement shown in FIG. 1 was adopted (Example 2). A high frequency wave glass antenna for an automobile was also fabricated in the arrangement shown in FIG. 13, using a front windshield mounted to the automobile (Example 3).

In each of the examples, the front windshield comprised a laminated glass sheet. The intermediate film 16 of the laminated glass sheet was made of polyvinylbutyral.

Since each of the arrangements shown in FIGS. 4 and 13 is directed to a monopole antenna, neither the grounding conductor 9 nor the grounded portion 8 was disposed in Examples 1 to 3.

In each of the examples, the antenna conductor and the feeding electrode 8 were formed on the car-exterior-side surface of a laminated glass sheet as the front windshield (not between the two glass sheets forming the laminated glass sheets) by affixing pieces of copper foil with a sticking agent. The opposite electrode 18 was formed by affixing copper foil on the car-interior-side surface of the laminated glass sheet with a sticking agent.

The front windshield was inclined at an angle of 38.5° in Examples 1 and 2 and at an angle of 31° in Example 3 with respect to a horizontal direction. In each of Examples 1 and 2, the first element 1 and the second element 2 were disposed so as to be parallel or substantially parallel to a horizontal surface.

In each of the examples, the front windshield was mounted to the automobile so that the vehicle opening edge for a window 5 was located at a position of about 10 mm in Examples 1 and 2 and about 30 mm in Example 3 apart from and inside the peripheral edge portion of the front windshield. The front windshield was mounted to the vehicle opening edge for a window 5 in such a way that the front windshield and the vehicle opening edge for a window 5 had an adhesive (having a thickness of about 5 mm) interposed therebetween.

In each of the examples, measurements were made for horizontally polarized waves. The measurements were made at frequencies of every 6 MHz in 473 to 575 MHz and at frequencies of every 18 MHz in 587 to 767 MHz.

In each of the examples, the center conductor of a coaxial cable was connected to the feed point 18a (not shown in FIG. 13), and the outer conductor was connected to a portion (metal portion) of the car body in the vicinity of the front windshield.

The antenna gains were found based on antenna gain average values (every 1°) within −90° to +90° in the horizontal direction (at a front-side portion of the automobile) when the center of the front of the automobile was set at 0 (zero)°, the left direction of the automobile was set at +90° and the center of the back of the automobile was set at +180°. The above-mentioned specifications for antenna gain measurements were applied to all characteristic graphs stated below.

The F/B ratio means a difference between an antenna gain average value (every 1°) within −90° to +90° in the horizontal direction (at the front-side portion of the automobile) and an antenna gain average value (every 1°) within +90° to +270° in the horizontal direction (at the back-side portion of the automobile) when the center of the front of the automobile was set at 0 (zero)°, the left direction of the automobile was set at +90° and the center of the back of the automobile was set at +180°.

As the F/B ratio decrease, the difference in antenna gains between the front-side portion of the automobile and the back-side portion of the automobile is minimized, with the result that the antenna has a directivity brought closer to non-directivity. To the contrary, as the F/B increase, the antenna has a strong directivity in the front-side portion of the automobile. The antenna gains were calculated by application of the area mean calculating method. The above-mentioned specifications for the F/B ratio measurements were applied to the characteristic graphs stated below.

The dimensions common to Examples 1 to 3 stated below were as follows:

| | | |
|---|---|---|
| Conductor width of antenna conductor or | 0.4 | mm |
| conductor width of second connecting | | |
| conductor 4 | | |
| Thickness of front windshield | 4.76 | mm |
| Thickness of car-interior-side glass sheet | 2 | mm |
| Thickness of car-exterior-side glass sheet | 2 | mm |
| Thickness of intermediate film 16 | 0.76 | mm |

### EXAMPLE 1

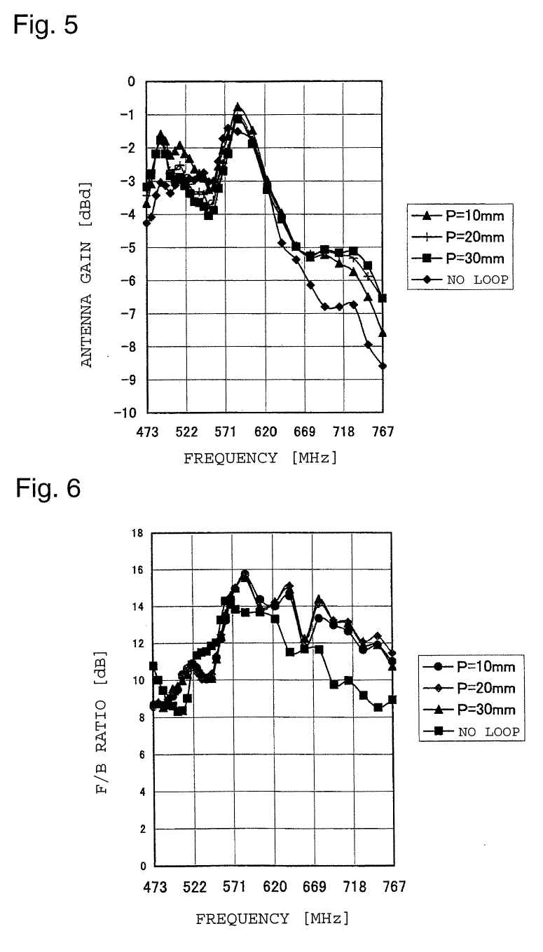

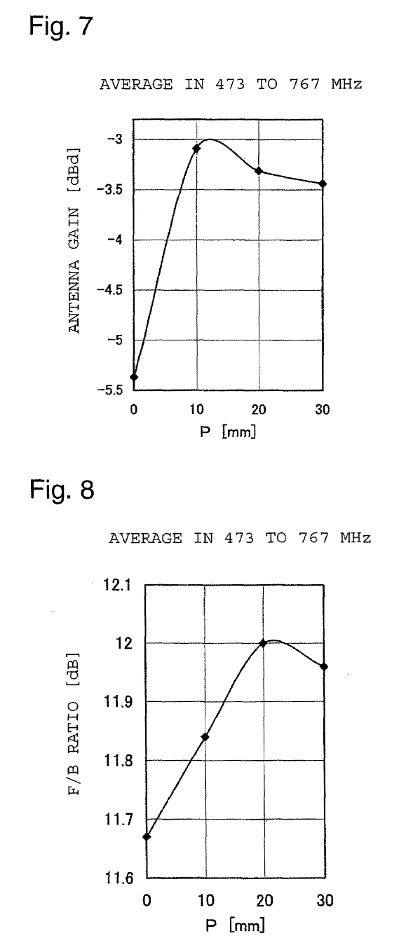

Measurements were made for the high frequency wave glass antenna for an automobile, which was fabricated as shown in FIG. 4. Frequency-antenna gain characteristics are shown in FIG. 5, and frequency-F/B ratio characteristics are shown in FIG. 6. P changed to 0 (zero) mm, 10 mm, 20 mm and 30 mm. P-antenna gain characteristics are shown in FIG. 7, and P-F/B ratio characteristics are shown in FIG. 8. In each of FIGS. 7 and 8, the point where B is 0 (zero) mm shows a case where no loop-forming element 6 is disposed. The dimensions of the respective portions were as follows:

| | | |
|---|---|---|
| L₁ | 80 | mm |
| Conductor length of first element 1 (straight | 85 | mm |
| portion plus curved portion in the vicinity of feeding | | |
| electrode 8) | | |
| L₂ (conductor length of second element: straight | 130 | mm |
| portion) | | |
| L₃ (distance between left edge portion of opposite | 10 | mm |
| electrode 18 and center of feed point 18a) | | |
| Conductor length of first connecting conductor 3 | 55 | mm |
| (semicircular portion) | | |
| W₁ | 35 | mm |
| W₂ | 17.5 | mm |
| D₁ | 8 | mm |
| D₂ | 50 | mm |
| Power source 8 (W₅ × W₃) | 12 × 45 | mm |
| Opposite electrode 18 (W₅ × W₄) | 12 × 55 | mm |

| | |
|---|---|
| Front windshield | 1,594 (maximum |
| | transverse |
| | length) × 772 |
| | (maximum vertical |
| | length) mm |

### EXAMPLE 2

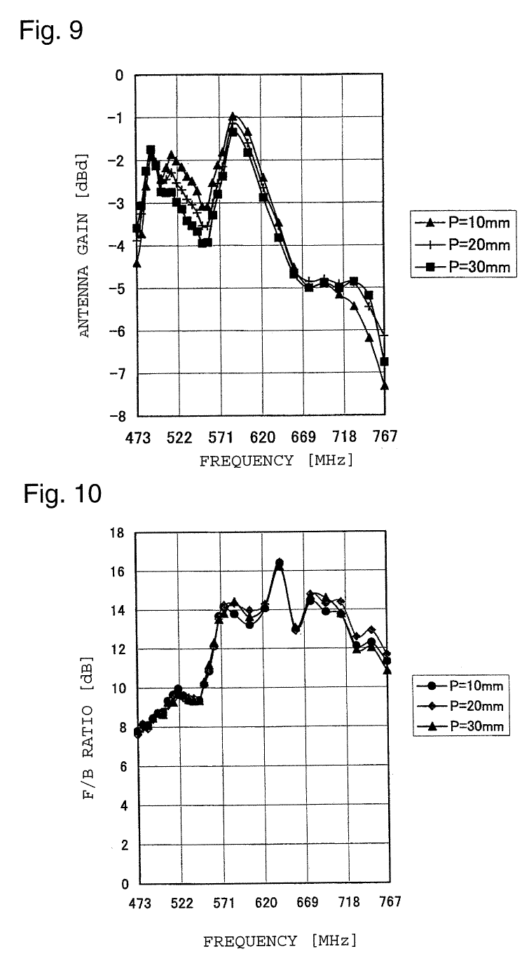

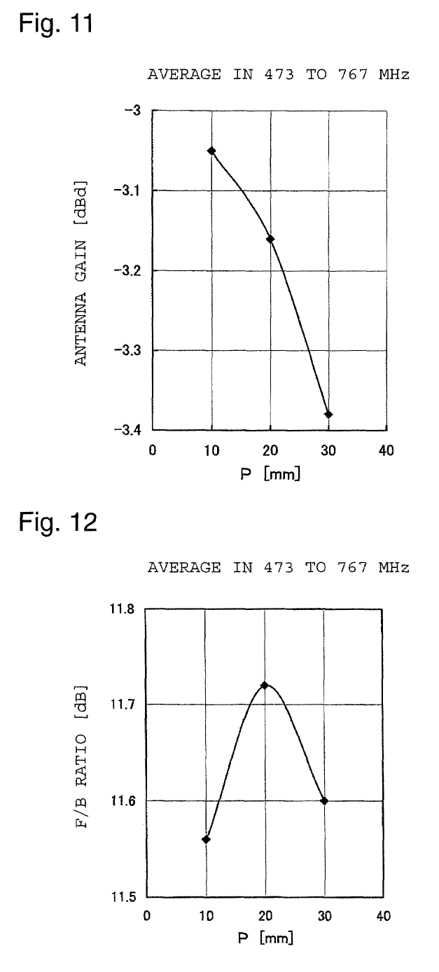

Measurements were made for the high frequency wave glass antenna for an automobile fabricated in the arrangement shown in FIG. 4 except that, instead of the antenna conductor shown in FIG. 4, the antenna conductor formed in the arrangement shown in FIG. 1 was adopted. Frequency-antenna gain characteristics are shown in FIG. 9, and frequency-F/B ratio characteristics are shown in FIG. 10. P-antenna gain characteristics are shown in FIG. 11, and P-F/B ratio characteristics are shown in FIG. 12. No second connecting conductor 4 was disposed.

The dimensions of L₂, D₁, D₂, P, L₃, the conductor length of the first connecting conductor 3 (semicircular portion), W₁, W₂ and the feeding electrode 8, the dimensions of the opposite electrodes 18, and the dimensions of the front windshield were the same as the dimensions of those in Example 1. The dimensions of the other portions were as follows:

| | |
|---|---|
| L₁ (conductor length of first element 1 in FIG. 1) | 80 mm |
| Conductor length of second grounding conductor 4 | 10 mm |

### EXAMPLE 3

The antenna conductor, the feeding electrode 8 and the opposite electrode 18, which were formed as shown in FIG. 13, were disposed on a right side of the front windshield with respect to the center thereof in a left-to-right direction thereof as viewed from the car-interior-side. The opposite electrode 18 was formed on the car-interior-side surface of the front windshield so that the center of the opposite electrode 18 overlapped with the center of the feed point 8 as viewed three-dimensionally. The feed point was formed at the center of the opposite electrode 18. Frequency-antenna gain characteristics are shown in FIG. 14. The dimensions of the portions that were not stated before were as follows:

| L₄ | 50 | mm |
|---|---|---|
| L₅ | 35 | mm |
| L₆ | 57 | mm |
| L₇ | 39 | mm |
| W₁ | 30 | mm |
| P | 10 | mm |
| θ | 61° | |
| Power source 8 (W₅ × W₃) | 10 × 45 | mm |
| Opposite electrode 18 (W₆ × W₄) | 14 × 55 | mm |
| D₁ | 10 | mm |

Shortest distance between center of front windshield in left-to-right direction and feeding electrode 8140 mm

Front Windshield
1,540 (maximum transverse length)×1,164 (maximum vertical length) mm

The present invention is applicable to a glass antenna for an automobile, which receives a digital terrestrial television broadcast, a UHF band analog television broadcast, a US digital television broadcast, an EU digital television broadcast or a Chinese digital television broadcast. The present invention is also applicable to the Japanese FM broadcast band (76 to 90 MHz), the US FM broadcast band (88 to 108 MHz), the television VHF band (90 to 108 MHz and 170 to 222 MHz), the 800 MHz band for automobile telephones (810 to 960 MHz), the 1.5 GHz band for automobile telephones (1.429 to 1.501 GHz), the UHF band (300 MHz to 3 GHz), the GPS (Global Positioning System), the GPS signal for artificial satellites (1,575.42 MHz) and the VICS (Vehicle Information and Communication System: 2.5 GHz).

Further, the present invention is also applicable to the ETC communication (Electronic Toll Collection System: non-stop automatic fare collection system, transmit frequency of roadside wireless equipment: 5.795 GHz or 5.805 GHz, reception frequency of roadside wireless equipment: 5.835 GHz or 5.845 GHz), the DSRC (Dedicated Short Range Communication in the 915 MHz band, the 5.8 GHz band and the 60 GHz band), communication using a microwave (1 GHz to 3 THz), communication using millimeter wave (30 to 300 GHz), communication for the automobile keyless entry system (300 to 450 MHz), and communication for the SDARS (Satellite Digital Audio Radio Service (2.34 GHz, 2.6 GHz)).

The entire disclosure of Japanese Patent Application No. 2006-162 filed on Jun. 12, 2006 including specification, claims, drawings and summary is incorporated herein by reference in its entirety.

What is claimed is:

1. A high frequency wave glass antenna comprising:
an antenna conductor and a feeding electrode for the antenna conductor disposed in or on an automobile window glass sheet, a signal received by the feeding electrode being transmitted to a receiver; and
the antenna conductor including a first antenna element, a second antenna element, a first connecting conductor and a loop-forming element;
wherein the first antenna element and the second antenna element are connected together by the first connecting conductor, such that the first antenna element, the second antenna element and the first connecting conductor form a conductor pattern in a U-character shape, a substantially U-character shape, a J-character shape or a substantially J-character shape;
wherein at least one of the first antenna element and the loop-forming element is directly connected to the feeding electrode or connected to the feeding electrode through a second connecting conductor disposed as required;
wherein when at least one of the first antenna element and the loop-forming element is directly connected to the feeding electrode, at least one of the first antenna element, the first connecting conductor and the feeding electrode, and the loop-forming element form a loop; and
wherein when at least one of the first antenna element and the loop-forming element are connected to the feeding electrode through the second connecting conductor, at least one of the first antenna element, the first connecting conductor, the second connecting conductor and the feeding electrode, and the loop-forming element form a loop.

2. The glass antenna according to claim 1, wherein when the first antenna element is directly connected to the feeding electrode, a leading edge portion of the first antenna element remote from the first connecting conductor or a portion of the first antenna conductor in the vicinity of the leading edge portion is connected to the feeding electrode, and
wherein when the first antenna element is connected to the feeding electrode through the second connecting conductor, the leading edge portion of the first antenna element remote from the first connecting conductor or a portion of the first antenna conductor in the vicinity of the leading edge portion is connected to the second connecting conductor.

3. The glass antenna according to claim 1, wherein the first antenna element has a straight portion disposed in the vicinity of a vehicle opening edge for a window; and
wherein the straight portion extends parallel or substantially parallel to the vehicle opening edge for a window.

4. The glass antenna according to claim 1, wherein the feeding electrode is disposed on a side opposite to the first connecting conductor as viewed from the center of the first antenna element;
wherein the loop-forming element starts at a portion of the first connecting conductor and extends parallel or substantially parallel to the first connecting conductor toward the feeding electrode; and
wherein the loop-forming element bends or curves toward the feeding electrode in the vicinity of the feeding electrode, such that the loop-forming element is connected to a leading edge portion of the first antenna element close to the feeding electrode or a portion of the first antenna element in the vicinity of the leading edge portion of the first antenna element close to the feeding electrode and is directly connected to the feeding electrode or connected to the feeding electrode through the second connecting conductor.

5. The glass antenna according to claim 1, wherein the feeding electrode is disposed on a side opposite to the first connecting conductor as viewed from the center of the first antenna element;
wherein the loop-forming element starts at a portion of the first connecting conductor and extends parallel or substantially parallel to the first connecting conductor toward the feeding electrode; and
wherein the first antenna element and the loop-forming element join together in the vicinity of the feeding electrode, being directly connected to the feeding electrode or connected to the feeding electrode through the second connecting conductor.

6. The glass antenna according to claim 1, wherein when the conductor pattern in a U-character shape, a substantially U-character shape, a J-character shape or a substantially J-character shape is called a turn conductor pattern,
a portion of the first antenna element, the second antenna element and the first connecting conductor form the turn conductor pattern,
the first antenna element, a portion of the second antenna element and the first connecting conductor form the turn conductor pattern, or
a portion of the first antenna element, a portion of the second antenna element and the first connecting conductor form the turn conductor pattern.

7. The glass antenna according to claim 1, wherein when the conductor pattern in a U-character shape, a substantially U-character shape, a J-character shape or a substantially J-character shape is called a turn conductor pattern,
the first antenna element is extended in a direction away from the first connecting conductor, followed by being bent or curved toward an outer direction of the turn conductor pattern.

8. The glass antenna according to claim 1, wherein when the conductor pattern in a U-character shape, a substantially U-character shape, a J-character shape or a substantially J-character shape is called a turn conductor pattern,
the second antenna element is extended in a direction away from the first connecting conductor, followed by being bent or curved toward an inner direction of the turn conductor pattern.

9. The glass antenna according to claim 1, further comprising an antenna element for short circuit, which connects between an arbitrary point of the loop and a point of the loop other than the arbitrary point.

10. The glass antenna according to claim 1, wherein the window glass sheet includes a grounded portion, which is disposed in the vicinity of the feeding electrode; and
wherein a signal received between the feeding electrode and the grounded portion is transmitted to the receiver.

11. The glass antenna according to claim 10, wherein the window glass sheet includes a grounded conductor; and
wherein the grounded portion is connected to a grounding connector.

12. The glass antenna according to claim 1, wherein a shortest distance between the feeding electrode and the grounded portion is 2 to 30 mm.

13. The glass antenna according to claim 1, wherein the first antenna element has a length of (1/2)·(359/4) to (3/2)·(359/4) mm; and
wherein the first antenna element, the first connecting conductor and the second antenna conductor have a total length of (3/2)·(359/4) to (9/2)·(359/4) mm.

14. The glass antenna according to claim 1, wherein when the center frequency of a desired broadcasting frequency band has a wavelength of λ₀ in air, when glass has a shortening coefficient of wavelength of k, when the formula of k=0.64 is established, and when the formula of λ_{g}=λ₀·k is established;
the first element is one of elements forming the loop,
a main portion of the first element and a main portion of the loop-forming element are parallel or substantially parallel to each other; and
a distance between the main portion of the first element 1 and the main portion of the loop-forming element is 0.0065λ_{g} or above.

15. The glass antenna according to claim 14, wherein the main portion of the first antenna element is 70% of a conductor length of the first antenna element, and
wherein the main portion of the loop-forming element is 70% of a conductor length of the loop-forming element.

16. The glass antenna according to claim 1, wherein when the center frequency of a desired broadcasting frequency band has a wavelength of λ₀ in air, when glass has a shortening coefficient of wavelength of k, when the formula of k=0.64 is established, and when the formula of λ_{g}=λ₀·k is established;
the first element is one of elements forming the loop, and
an average distance between the first antenna element and the loop-forming element is 0.0065λ_{g} or above.

17. The glass antenna according to claim 1, wherein an average distance between the second antenna element and the loop-forming element is 0.0065λ_{g} or above.

18. The glass antenna according to claim 1, wherein when the center frequency of a desired broadcasting frequency band has a wavelength of λ₀ in air, when glass has a shortening coefficient of wavelength of k, when the is formula of k=0.64 is established, and when the formula of λ_{g}=λ₀·k is established;
a distance between the first antenna element and the second antenna element is 0.0565λ_{g} to 0.170λ_{g}.

19. The glass antenna according to claim 1, wherein the feeding electrode is formed in such a shape as to have a longitudinal direction, and
the longitudinal direction of the feeding electrode is parallel or substantially parallel to an extending direction or a longitudinal direction of a main portion of the first antenna element.

20. The glass antenna according to claim 19, wherein when the center frequency of a desired broadcasting frequency band has a wavelength of λ₀ in air, when glass has a shortening coefficient of wavelength of k, when the formula of k=0.64 is established, and when the formula of λ_{g}=λ₀·k is established;
the feeding electrode has a maximum width of 0.0727λ_{g} to 0.218λ_{g} in the longitudinal direction thereof.

21. The glass antenna according to claim 1, wherein the first connecting conductor is formed in the shape of an arc of a semicircle, a substantially semicircle, a semi-oval or a substantially semi-oval.

22. The glass antenna according to claim 1, wherein the window glass sheet comprises a laminated glass sheet including two glass sheets bonded together through a bonding layer; and
wherein the first antenna element, the second antenna element, the first connecting conductor, the loop-forming element and the feeding electrode as well as the second connecting conductor disposed as required are disposed between the two glass sheets; and
the glass antenna further comprising an opposite electrode at a position on a car-interior-side surface of the laminated glass sheet so as to confront the feeding electrode;
wherein a signal received by the feeding electrode is transmitted to the opposite electrode by at least one of capacitive coupling and electromagnetic coupling; and
wherein the signal received by the opposite electrode is transmitted to the receiver.

23. The glass antenna according to claim 22, wherein at least one of the first antenna element, the second antenna element, the first connecting conductor, the loop-forming element, the feeding electrode and the second connecting conductor disposed as required is disposed on one of confronting surfaces of the two glass sheets.

24. The glass antenna according to claim 22, wherein the opposite electrode is formed in such a shape as to have a longitudinal direction; and
wherein a maximum width of the opposite electrode in the longitudinal direction thereof is 1.03 to 1.5 times a maximum width of the feeding electrode in a longitudinal direction thereof.

25. The glass antenna according to claim 22, wherein each of the feeding electrode and the opposite electrode is formed in such a shape as to have a longitudinal direction;
wherein the longitudinal direction of the feeding electrode and the longitudinal direction of opposite electrode are parallel or substantially parallel to each other; and
wherein the opposite electrode has a feed point formed therein, and the feed point is disposed closer to the first antenna element than the center of the opposite electrode.

26. The glass antenna according to claim 1, wherein the antenna conductor is configured to have a function of receiving a digital television broadcast band in terms of shape and dimensions.

27. The glass antenna according to claim 1, wherein the antenna conductor is disposed in or on a plastic film, and the plastic film is disposed in or on the window glass sheet.

28. The glass antenna according to claim 1, wherein a received radio wave contains a frequency ranging from 470 to 770 MHz.

29. The glass antenna according to claim 1, wherein a received radio wave contains a frequency ranging from 698 to 806 MHz.

30. A window glass sheet for an automobile, including the feeding electrode and the antenna conductor recited in claim 1.
